(19) United States
(12) Patent Application Publication
(10) Pub. No.: US 2014/0193689 A1
(43) Pub. Date: Jul. 10, 2014

(54) ELECTROCHEMICAL CELL, METHOD OF PRODUCING ELECTROCHEMICAL CELL, BATTERY PACK, AND CAR

(71) Applicant: KABUSHIKI KAISHA TOSHIBA, Tokyo (JP)

(72) Inventors: Norio TAKAMI, Yokohama-shi (JP); Yasuhiro HARADA, Yokohama-shi (JP); Keigo HOSHINA, Yokohama-shi (JP)

(73) Assignee: KABUSHIKI KAISHA TOSHIBA, Tokyo (JP)

(21) Appl. No.: 14/202,753

(22) Filed: Mar. 10, 2014

Related U.S. Application Data
(63) Continuation of application No. PCT/JP2012/057309, filed on Mar. 22, 2012.

(51) Int. Cl. H01M 10/0562; H01M 10/0585; H01M 10/615; H01M 10/0525

(52) U.S. Cl. CPC H01M 10/0562; H01M 10/0525; H01M 10/0585; H01M 10/5006
USPC 429/120; 429/304; 156/60

(57) ABSTRACT

According to one embodiment, an electrochemical cell includes a positive electrode, a negative electrode, a sulfide-based solid electrolyte layer and an oxide-based solid electrolyte layer. The positive electrode includes positive electrode active material particles which absorb and release lithium ions at a potential of 3 V (vs. Li/Li⁺) or more. The sulfide-based solid electrolyte layer is bonded to the negative electrode. The oxide-based solid electrolyte layer has a thickness of 0.5 μm or less and is provided on surfaces of the positive electrode active material particles.

### CROSS-REFERENCE TO RELATED APPLICATIONS

This application is a Continuation Application of PCT Application No. PCT/JP2012/057309, filed Mar. 22, 2012, the entire contents of which are incorporated herein by reference.

### FIELD

Embodiments described herein relate to a method of producing an electrochemical cell, an electrochemical cell, a battery pack, and a car.

### BACKGROUND

A nonaqueous electrolyte battery in which a lithium metal, a lithium alloy, a lithium compound or a carbonaceous material is used for a negative electrode is expected to provide a battery of a high energy density, and active research and development have been conducted. A lithium ion battery comprising a positive electrode containing LiCoO₂, LiMn₂O₄, LiFePO₄ or LiNi_{1/3}Co_{1/3}Mn_{1/3}O₂ as an active material and a negative electrode containing a carbonaceous material that absorbs and releases lithium has been widely put to practical use as a power source for a portable device.

In the case of mounting the battery in a vehicle such as an automobile, a bus or a train, the positive and negative electrodes are required to be formed of a material excellent in chemical and electrochemical stability, in mechanical strength and in corrosion resistance in view of storage performance in high-temperature environments (at 60° C. or more), cycle performance, and reliability of high power over a long time. Further, high-output performance in a low temperature environment (−40° C.) and long life performance are required to achieve high performance in cold climates. On the other hand, a nonvolatile and noncombustible solid electrolyte has been developed as the nonaqueous electrolyte from the viewpoint of resolving the problems such as liquid leakage and gas generation and improved safety performance. However, the solid electrolyte has low ion conductivity and the interface resistance between the electrode and the solid electrolyte is high and thus the input/output performance and low-temperature performance of a battery is poor. Further, a battery formed using the solid electrolyte has not yet been put to practical use because the lifetime of the battery is shortened by an increase in the interface resistance between the electrode and the solid electrolyte in the storage or charge and discharge cycle at high temperatures.

In order to mount the nonaqueous electrolyte battery including a solid electrolyte on a vehicle, the major objective is to achieve output performance, low-temperature performance, and life performance at high temperatures. Further, it is difficult to mount the nonaqueous electrolyte battery on an engine room of the vehicle in place of a lead storage battery.

### BRIEF DESCRIPTION OF DRAWINGS

FIG. 1 is a cross-sectional view showing a solid electrolyte secondary battery according to one embodiment.

FIG. 2 is a cross-sectional view showing a bipolar battery according to one embodiment.

FIG. 3 is a pattern diagram of a car according to one embodiment.

### DETAILED DESCRIPTION

According to one embodiment, an electrochemical cell includes a positive electrode, a negative electrode, a sulfide-based solid electrolyte layer and an oxide-based solid electrolyte layer. The positive electrode includes positive electrode active material particles which absorb and release lithium ions at a potential of 3 V (vs. Li/Li⁺) or more. The negative electrode includes a negative electrode active material. The sulfide-based solid electrolyte layer is bonded to the negative electrode. The oxide-based solid electrolyte layer has a thickness of 0.5 μm or less and is provided on surfaces of the positive electrode active material particles.

According to the embodiment, there is provided a battery pack including the electrochemical cell.

According to the embodiment, there is provided a car including the battery pack.

According to the embodiment, there is provided a method of producing an electrochemical cell. The method includes forming a positive electrode material layer on a surface of a positive electrode current collector using a nonaqueous slurry to produce a positive electrode. The nonaqueous slurry contains an oxide-based solid electrolyte, positive electrode active material particles absorbing and releasing lithium ions at a potential of 3 V (vs. Li/Li⁺) or more and an oxide-based solid electrolyte layer provided on surfaces of the positive electrode active material particles. The method includes forming a negative electrode material layer on a surface of a negative electrode current collector using a slurry to produce a negative electrode. The slurry contains a negative electrode active material and a sulfide-based solid electrolyte. The method further includes disposing the positive electrode and the negative electrode with interposing a sulfide-based solid electrolyte layer between the positive electrode material layer and the negative electrode material layer, and with providing a carbon layer on the positive or negative electrode material layer, or the positive or negative electrode current collector, and integrating a resulting laminate by thermocompression bonding.

Hereinafter, embodiments will be described with reference to the drawings.

### First Embodiment

According to a first embodiment, there is provided a electrochemical cell including: a positive electrode; a negative electrode containing a negative electrode active material; a sulfide-based solid electrolyte layer; and an oxide-based solid electrolyte layer. The ionic conduction between the negative electrode and the sulfide-based solid electrolyte layer can be increased by contacting the sulfide-based solid electrolyte layer to the negative electrode. Thus, the interface resistance between the negative electrode and the sulfide-based solid electrolyte layer can be decreased. On the other hand, the positive electrode includes the positive electrode active material particles which absorb and release lithium ions at a potential of 3 V or more (based on lithium potential, hereinafter referred to as “vs. Li/Li⁺”). Thus, the contact with the sulfide-based solid electrolyte layer results in progression of the abstraction of lithium in the sulfide-based solid electrolyte layer to the positive electrode. If the lithium concentration of the sulfide-based solid electrolyte layer is lowered, the ionic conductivity of the sulfide-based solid electrolyte layer is lowered. The decrease in the ionic conductivity of the solid electrolyte layer leads to a decrease in discharge performance, low-temperature performance, cycle life performance, and high-temperature storage performance. The surfaces of positive electrode active material particles are covered with an oxide-based solid electrolyte layer having a thickness of 0.5 μm or less so that the lithium abstraction from the sulfide-based solid electrolyte by the positive electrode active material can be suppressed without inhibiting the absorbing and releasing of lithium ions of the positive electrode. Thus, it is possible to attain a high ionic conductivity, which is the feature of the sulfide-based solid electrolyte layer. Further, since the oxide-based solid electrolyte is electrochemically and chemically stable, it has a low reactivity with the positive electrode active material having a high potential and can improve the life performance of the positive electrode. As a result, in an electrochemical cell including a positive electrode active material having a high potential (3 V (vs. Li/Li⁺) or more), the interface resistance between the positive and negative electrodes and the electrolyte and the electrolyte resistance can be reduced. Thus, it is possible to provide an electrochemical cell excellent in discharge performance, low-temperature performance, cycle life performance, and high-temperature storage performance.

Hereinafter, the oxide-based solid electrolyte, the sulfide-based solid electrolyte, and the positive and negative electrodes will be described.

### 1) Oxide-Based Solid Electrolyte

The solid electrolyte bonded to the positive electrode active material is an oxide-based solid electrolyte. Examples of the oxide-based solid electrolyte include perovskite-type, garnet-type, LISICON, LIPON, NASICON, and titanium-based oxides. The perovskite-type oxide-based solid electrolyte is preferably La₃ₓLi_{2/3-x}TiO₃ (0≦x≦2/3). Li_{0.35}La_{0.55}TiO₃ is more preferred because it exhibits high ion conductivity. The garnet-type oxide-based solid electrolyte is preferably Li₅LaM₂O₁₂ (M represents Ta or Nb or Ta and Nb). The oxide-based solid electrolyte called “LISICON” is preferably Li₁₄ZnGe₄O₁₆. The oxide-based solid electrolyte called “LIPON” is preferably Li₃PO₄₋ₓNₓ (0≦x≦0.5). The oxide-based solid electrolyte called “NASICO” is preferably Li₁₊ₓAlₓM₂₋ₓ(PO₄)₃ (M represents Ti or Ge or Ti and Ge, wherein 0≦x≦0.5). Preferable examples of the titanium oxide-based solid electrolyte include Li₄Ti₅O₁₂ having a spinel structure, LiTi₂O₄, LiₓTiO₂ having an anatase structure (0≦x≦1), LiₓTiO₂ (B) having a monoclinic structure (0≦x≦1), LiₓTiO₂ having a ramsdellite structure (0≦x≦1), and LiₓTiO₂ having a hollandite structure (0≦x≦1). Since those kinds of the oxide-based solid electrolytes are electrochemically and chemically stable, they have a low reactivity with the positive electrode active material having a high potential and can improve the life performance of the positive electrode. The oxide-based solid electrolyte may be of one kind or two kinds or more.

### 2) Sulfide-Based Solid Electrolyte

The solid electrolyte bonded to the negative electrode active material is a sulfide-based solid electrolyte. Examples of the sulfide-based solid electrolyte include a thio silicon compound and a sulfide glass-ceramic compound. If the thio silicon compound is a sulfide represented by Li₄₋ₓA_{1-y}B_{y}S₄ (A represents Si or Ge or Si and Ge. B represents at least one element selected from the group consisting of P, Al, Zn, and Ga, wherein 0≦x≦1, 0≦y≦1), the ion conductivity is high. Thus, this is preferred. More preferably, the composition is Li_{10/3}Ge_{1/3}P_{2/3}S₄. The sulfide glass-ceramic compound is preferably a glassy sulfide such as Li₂S—P₂S₅, Li₂S—Si₂S₂, Li₂S—P₂S₅—Li₄SiO₄, Li₂S—Ga₂S₃—GeS₂ or Li₂S—Sb₂S₃—GeS₂. Since the ion conductivity of the sulfide-based solid electrolyte is higher than that of the oxide-based solid electrolyte, the cell output performance can be improved. The sulfide-based solid electrolyte may be one kind or two kinds or more.

The strength of the sulfide-based solid electrolyte layer may be improved by dispersing metallic oxide particles such as alumina (Al₂O₃), silicon oxide (SiO₂), and zirconium oxide (ZrO) into the sulfide-based solid electrolyte layer or compounding metallic oxide particles with the sulfide-based solid electrolyte. Thus, short circuits can be prevented and the thickness of the electrolyte layer can be made thin. Al₂O₃ particles are preferred because of their high electrochemical and chemical stability. The average particle size (diameter) of the metallic oxide particles is preferably from 0.01 to 5 μm. The metal oxide may be of one kind or two kinds or more.

The thickness of the sulfide-based solid electrolyte layer is preferably 5 μm or more, more preferably from 10 to 100 μm. The thickness of the sulfide-based solid electrolyte layer is measured by, for example, observation with a transmission electron microscope (TEM).

### 3) Positive Electrode

The positive electrode includes a positive electrode current collector and a positive electrode material layer including the positive electrode active material, a conductive agent, and a binder, which is supported on one surface or both sides of the positive electrode current collector.

The positive electrode active material which absorbs and releases lithium ions at a potential of 3 V (vs. Li/Li⁺) or more (based on lithium potential) is preferably a metal oxide. For example, a lithium metal oxide containing at least one metallic element selected from the group consisting of cobalt, nickel, and manganese can have a potential 4 V (vs. Li/Li⁺) or more.

Examples of the positive electrode active material which absorbs and releases lithium ions at a potential of 3 V (vs. Li/Li⁺) or more include a lithium manganese composite oxide (e.g., LiₓMn₂O₄ or LiₓMnO₂), a lithium nickel composite oxide (e.g., LiₓNᵢO₂), a lithium cobalt composite oxide (e.g., LiₓCoO₂), a lithium nickel cobalt composite oxide (e.g., LiₓNi_{1-y}Co_{y}O₂), a lithium manganese cobalt composite oxide (e.g., LiₓMn_{y}Co_{1-y}O₂), a spinel-type lithium manganese nickel composite oxide (e.g., LiₓMn_{2-y}Ni_{y}O₄, 0≦x≦1, 0.4≦y≦1), a lithium phosphorus oxide having an olivine structure (e.g., LixFePO4, LixFeMn_{1-y}PO₄, LiₓVPO₄F, LiₓCoPO₄), an iron sulfate compound (LiₓFeSO₄F, FeSO₄), and a lithium nickel cobalt manganese composite oxide having a layer crystal structure. Unless otherwise stated, x and y are preferably from 0 to 1.

In order to produce an electrochemical cell having a high voltage and excellent output performance, it is preferable to use a lithium manganese composite oxide, a lithium nickel composite oxide, a lithium cobalt composite oxide, a lithium nickel cobalt composite oxide, a spinel-type lithium manganese nickel composite oxide, a lithium manganese cobalt composite oxide, lithium iron phosphate, a lithium nickel cobalt manganese composite oxide having a layer crystal structure or the like.

LiMn_{1.5}Ni_{0.5}O₄ of the spinel-type lithium manganese nickel composite oxide (LiₓMn_{2-y}Ni_{y}O₄, 0≦x≦1, 0.4≦y≦1) has a high average potential of 4.7 V (vs. Li/Li⁺). Thus, the use thereof in combination with a negative electrode containing Li₄Ti₅O₁₂ allows the energy density to be improved.

The composition of the lithium nickel cobalt manganese composite oxide having a layer crystal structure is preferably represented by LiₐNi_{b}Co_{c}Mn_{d}O₂ (wherein the molar ratio of a:b:c:d is 0≦a≦1.1 and b+c+d=1). More preferably, the molar ratio of a:b:c:d is in the range of 0≦a≦1.1, 0.3≦b≦0.9, 0.1≦c≦0.5, 0.1≦d≦0.5. If it is within this range, a high capacity can be obtained.

The thickness of the oxide-based solid electrolyte layer is preferably 0.5 μm or less. The thickness of the oxide-based solid electrolyte layer is measured by, for example, observation with a transmission electron microscope (TEM). When a portion where the thickness of oxide-based solid electrolyte layer is the thinnest is 0.5 μm or less, the thickness of the oxide-based solid electrolyte layer is 0.5 μm or less. This is because, in the case of one having the portion where the thickness of oxide-based solid electrolyte layer is the thinnest is 0.5 μm or less, the absorbing and releasing of lithium to the positive electrode active material are not blocked and the resistance can be greatly reduced. The thickness of the oxide-based solid electrolyte layer is more preferably 0.02 μm or less, still more preferably from 0.001 to 0.01 μm, still more preferably from 0.001 to 0.005 μm. As a result, a sufficient bonding between the positive electrode active material and the oxide-based solid electrolyte layer is achieved. Thus, the interface resistance can be decreased. Then oxide-based solid electrolyte layer is produced by, for example, the following method. Composite particles containing positive electrode active material particles and nano-sized particles (e.g., 0.01 μm or less) of an oxide-based solid electrolyte or precursor of an oxide-based solid electrolyte are formed and subjected to a heat treatment (e.g., at 500 to 1000° C.) so that the positive electrode active material and the oxide-based solid electrolyte can be compounded. Further, it is preferable that the oxide-based solid electrolyte layer is present on the surfaces of the positive electrode active material particles and is provided interposed between the positive electrode and the sulfide-based solid electrolyte layer.

The thickness of the positive electrode material layer on one surface of the current collector is preferably from 1 to 150 μm. The thickness of the layer on one surface of the current collector is more preferably from 5 to 100 μm.

Examples of the conductive agent may include acetylene black, carbon black, and graphite.

Examples of the binder include polytetrafluoroethylene (PTFE), polyvinylidene fluoride (PVdF), fluorine rubber, and polyimide. Further, a polymer solid electrolyte such as polyethylene oxide (PEO) may be used.

As for the compounding ratio of the positive electrode active material to which the oxide-based solid electrolyte is bonded by coating, the conductive agent, and the binder, it is preferable that the content of the positive electrode active material is from 80 to 95% by mass, the content of the conductive agent is from 3 to 19% by mass, and the content of the binder is from 1 to 7% by mass. Further, it is configured that the porous portion (20 to 70% by volume) is filled with an oxide-based or sulfide-based solid electrolyte powder.

The positive electrode is produced, for example, by suspending the positive electrode active material particles whose surfaces are covered with the oxide-based solid electrolyte layer, the conductive agent, the oxide-based solid electrolyte, and the binder in an appropriate solvent to prepare a slurry, applying the resulting slurry to the positive electrode current collector, drying it, and heat-pressing it. The ratio of the oxide-based solid electrolyte in the positive electrode material layer (except the current collector) is preferably from 20 to 70% by volume. As the solvent, a nonaqueous solvent such as n-methyl pyrrolidone (NMP) is used.

As the positive electrode current collector, for example, an aluminum foil, an aluminum alloy foil, a stainless steel foil or a nickel foil may be used. The thickness of the positive electrode current collector is preferably 20 μm or less.

A carbon layer may be provided between the positive electrode current collector and the positive electrode material layer. Accordingly, the adhesion between the positive electrode current collector and the positive electrode material layer can be improved. This allows the resistance of the positive electrode to be decreased.

### 4) Negative Electrode

The negative electrode includes a negative electrode current collector and a negative electrode material layer including a negative electrode active material, a conductive agent, and a binder, which is supported on one surface or both sides of the current collector.

The negative electrode active material is one that absorbs and releases lithium ions. Examples of the negative electrode active material include lithium alloys, carbon materials, and metal compounds. More preferable examples of the negative electrode active material include lithium titanium oxides, titanium oxide, niobium oxides, silicon oxides, silicon, silicon alloys, iron oxides (e.g., Fe₂O₃, Fe₃O₄, and FeO), manganese oxides (e.g., MnO), zinc oxides (e.g., ZnO), and metal sulfides. When one of those negative electrode active materials is used, the reductive decomposition of the sulfide-based solid electrolyte is suppressed. Thus, the life performance can be improved. The negative electrode active material may be of one kind or two or more kinds.

The lithium alloy preferably contains at least one metallic element selected from the group consisting of Si, Al, Zn, Sn, and In. As a lithium titanium oxide, for example, Li₄₊ₓTi₅O₁₂ having a spinel structure (−1≦x≦3), Li₂₊ₓTi₃O₇ having a ramsdellite structure (0≦x≦1), Li₁₊ₓTi₂O₄ (0≦x≦1), Li_{1.1+x}Ti_{1.8}O₄ (0≦x≦1), Li_{1.07+x}Ti_{1.86}O₄ (0≦x≦1) , and LiₓTiO₂ (0≦x≦1) may be used. These kinds of lithium titanium oxides have a small volume change during absorbing and releasing of lithium. Examples of the titanium oxide include TiO₂ having an anatase structure and monoclinic TiO₂(B). Examples of the niobium oxide include Nb₂O₅ and TiNb₂O₇. Examples of the silicon oxide include SiO and Si—SiO composites. Examples of the silicon alloy include Si—Sn and Si—Li. Examples of the metal sulfide include TiS₂, FeS, FeS₂, NiS, and MoS₂.

The average particle size of the negative electrode active material particles is preferably set to a range of 0.01 to 10 μm. Regardless of whether the particle form is granular or fibrous, a good performance is obtained. In the case of the fibrous particles, the fiber diameter is preferably 0.1 μm or less.

Regarding the negative electrode active material, the specific surface area measured by the BET adsorption method based on N² adsorption is preferably from 0.5 to 100 m²/g. Thus, it is possible to further increase the affinity with the sulfide-based solid electrolyte.

The ratio of the sulfide-based solid electrolyte in the negative electrode material layer is preferably set to a range of 20 to 70% by volume. Thus, it is possible to produce a negative electrode having excellent affinity with the nonaqueous electrolyte and high density. The range is more preferably from 25 to 50% by volume.

The negative electrode current collector is preferably an aluminum foil, an aluminum alloy foil or a copper foil. The thickness of the aluminum foil and aluminum alloy foil is 20 μm or less, more preferably 15 μm or less. The purity of the aluminum foil is preferably 99.99% by mass or more. The aluminium alloy preferably contains at least one element selected from the group consisting of magnesium, zinc, and silicon. The content of transition metals such as iron, copper, nickel, or chromium is preferably set to 100 mass ppm or less.

A carbon layer may be provided between the negative electrode current collector and the negative electrode material layer. Accordingly, the adhesion between the negative electrode current collector and the negative electrode material layer can be improved. This allows the negative electrode resistance to be decreased.

Examples of the conductive agent may include acetylene black, carbon black, coke, carbon fiber, graphite, metal compound powder, and metal powder. More preferable examples thereof include coke having an average particle size of 10 μm or less (heat treatment temperature: 800° C. to 2000° C.), graphite, and metal powders such as TiO, TiC, TiN, Al, Ni, Cu, or Fe.

Examples of the binder include polytetrafluoroethylene (PTFE), polyvinylidene fluoride (PVdF), fluorine rubber, styrene butadiene rubber, core shell binders, and polyimide. Further, polymer solid electrolytes such as polyethylene oxide (PEO) may be used.

As for the compounding ratio of the negative electrode active material, the conductive agent, and the binder, it is preferable that the content of the negative electrode active material is from 80 to 95% by mass, the content of the conductive agent is from 1 to 18% by mass, and the content of the binder is from 2 to 7% by mass. The negative electrode preferably has a porous portion (20 to 70% by volume) filled with the sulfide-based solid electrolyte.

The negative electrode is produced, for example, by suspending the negative electrode active material, conductive agent, and binder in an appropriate solvent, adding a sulfide-based solid electrolyte powder thereto, applying the resulting slurry to the current collector, drying it, and heat-pressing it.

The oxide-based solid electrolyte, the sulfide-based solid electrolyte, the positive electrode, and the negative electrode are housed in a case. As the case, a metal case or a case formed of a laminate film may be used.

As the metal case, a metal can which is formed of aluminium, an aluminium alloy, iron or stainless steel and has a rectangular or cylindrical shape may be used. The thickness of the case is set to preferably 0.5 mm or less, more preferably 0.3 mm or less.

Examples of the laminate film may include a multilayer film obtained by coating an aluminum foil with a resin film. Polymers such as polypropylene (PP), polyethylene (PE), nylon, or polyethylene terephthalate (PET) may be used for the resin. The thickness of the laminate film is preferably 0.2 mm or less. The purity of the aluminum foil is preferably 99.5% or more.

The metal can consisting of an aluminium alloy is preferably formed of an alloy having an aluminum purity of 99.8% by mass or less which contains elements such as manganese, magnesium, zinc, or silicon. The thickness of the can may be reduced by increasing the strength of the metal can consisting of an aluminium alloy. As a result, an electrochemical cell which is thin and lightweight and has an excellent heat releasing property can be attained.

Examples of the electrochemical cell include solid electrolyte secondary batteries and bipolar batteries. The basic structure of a solid electrolyte secondary battery is a unit cell including a solid electrolyte layer interposed between a positive electrode and a negative electrode. On the other hand, the basic structure of a bipolar battery is one in which a plurality of unit cells of solid electrolyte secondary batteries are included, and a positive electrode current collector of one of the adjacent unit cells is electrically connected to a negative electrode current collector of the other of the unit cells. It is preferable that the positive electrode current collector is electrically connected to the negative electrode current collector by providing a carbon layer therebetween. Accordingly, the positive electrode current collector and the negative electrode current collector are easily connected with low resistance. Further, the carbon layer becomes a heating element by Joule heat during charge and discharge so that the input/output performance of the battery can be improved.

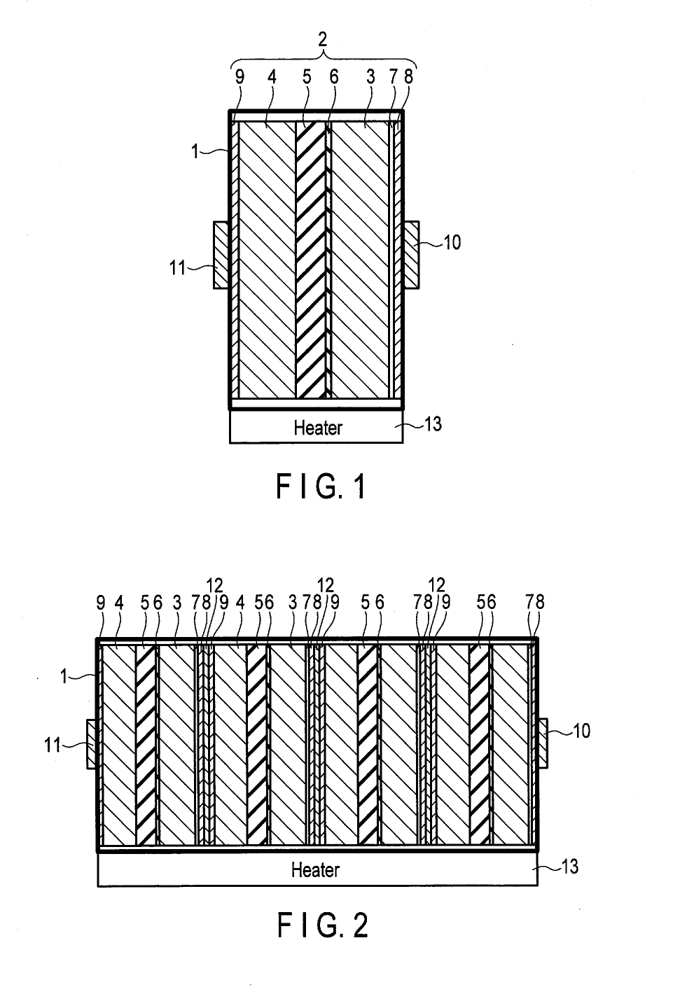

FIG. 1 shows an example of the thin-type solid electrolyte secondary battery according to the embodiment. Further, FIG. 2 shows an example of a bipolar battery including a thin-type solid electrolyte secondary battery.

As shown in FIG. 1, the solid electrolyte secondary battery includes a metal case 1 and an electrode group 2 that is housed in the case 1. The electrode group 2 includes a positive electrode material layer 3, a negative electrode material layer 4, a sulfide-based solid electrolyte layer 5, an oxide-based solid electrolyte layer 6, a carbon layer 7, a positive electrode current collector 8, and a negative electrode current collector 9. The sulfide-based solid electrolyte layer 5 is disposed between the positive electrode material layer 3 and the negative electrode material layer 4, and is bonded to the negative electrode material layer 4. The oxide-based solid electrolyte layer 6 is interposed between the positive electrode material layer 3 and the sulfide-based solid electrolyte layer 5. The carbon layer 7 is bonded to the positive electrode material layer 3, and the positive electrode current collector 8 is bonded to the carbon layer 7. The negative electrode current collector 9 is bonded to the negative electrode material layer 4. A positive electrode terminal 10 is fixed to the case 1 through an insulating member (not shown) and is electrically connected to the positive electrode current collector 8. A negative electrode terminal 11 is fixed to the case 1 through an insulating member (not shown) and is electrically connected to the negative electrode current collector 9. The positive electrode and the negative electrode are electrically insulated from the case 1.

As shown in FIG. 2, the bipolar battery includes a plurality of the electrode groups 2 to be used for the solid electrolyte secondary battery as unit cells. The positive electrode current collector 8 of one of the adjacent unit cells faces the negative electrode current collector 9 of the other unit cell. A carbon layer 12 is interposed between the positive electrode current collector 8 of one of the unit cells and the negative electrode current collector 9 of the other unit cell, and electrically connect them. A plurality of unit cells are connected in series through the carbon layer 12 interposed between the positive electrode current collector 8 and the negative electrode current collector 9.

Members such as charging and discharging circuits are connected to each of the solid electrolyte battery and the bipolar battery and stored in each casing. Each of the resulting products may be used as a battery pack. The battery pack may comprise a heater for heating a solid electrolyte battery or a bipolar battery. For example, for the solid electrolyte battery shown in FIG. 1 and the bipolar battery shown in FIG. 2, a heater 13 may be disposed at the position opposed to the surface of the case 1 on which the positive electrode terminal 10 and the negative electrode terminal 11 are not formed. When the temperature is low, the solid electrolyte battery and the bipolar battery are heated with the heater 13 so that the low-temperature performance of the battery can be improved. As a result, an excellent discharge performance can be exerted in low- and high-temperature environments. As the power source of the heater, an external power source may be used for both the solid electrolyte battery and the bipolar battery.

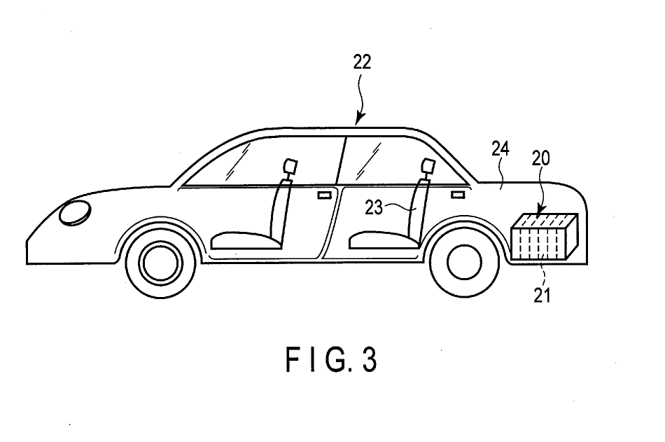

The application of the battery pack when used for the electrochemical cell is not particularly limited. Examples thereof include uses for vehicles such as cars (including motorcycles), bicycles, buses, and trains. FIG. 3 shows an example of a car equipped with a battery pack that includes the battery according to the first embodiment. A battery pack 20 includes a plurality of batteries 21 according to the first embodiment. For example, in a sedan 22 shown in FIG. 3, the battery pack may be arranged inside a trunk room 24 behind a rear sheet 23. The arrangement of the battery pack 20 is not limited thereto. The battery pack 20 may be arranged under or behind the sheet 23 or below the floor.

A carbon layer may be provided on the positive or negative electrode material layer, or the positive or negative electrode current collector.

According to the first embodiment described above, the oxide-based solid electrolyte layer having a thickness of 0.5 μm or less is formed on the surfaces of positive electrode active material particles which absorb and release lithium ions at a potential of 3 V (vs. Li/Li⁺) or more, and the sulfide-based solid electrolyte layer is bonded to the negative electrode. Therefore, the interface resistance between the positive electrode and the solid electrolyte layer as well as the interface resistance of the negative electrode and the solid electrolyte layer can be reduced. Thus, an increase in resistance due to charge/discharge cycles can be suppressed. As a result, it is possible to provide an electrochemical cell excellent in discharge performance, low-temperature performance, cycle life performance, and high-temperature storage performance, a battery pack using the same, and a car using the same.

### Second Embodiment

According to a second embodiment, there is provided a method of producing an electrochemical cell. The production method includes the step of producing a positive electrode, the step of producing a negative electrode, and the thermocompression-bonding step. Either the step of producing a positive electrode or the step of producing a negative electrode may be performed first or both of the steps may be performed simultaneously.

The step of producing a positive electrode comprises forming a positive electrode material layer on the surface of a positive electrode current collector using a nonaqueous slurry. The nonaqueous slurry contains positive electrode active material particles and an oxide-based solid electrolyte. The positive electrode active material particles absorbs and releases lithium ions at a potential of 3 V (vs. Li/Li⁺) or more, and are covered with an oxide-based solid electrolyte layer. The step of producing a positive electrode may be performed by the method described in the first embodiment. Here, a nonaqueous solvent such as n-methyl pyrrolidone (NMP) is used as the solvent in order to ensure the safety during production. That is, if water is included in the positive electrode slurry, the water may react with the sulfide-based solid electrolyte layer at the side of the negative electrode to generate hydrogen sulfide.

The step of producing a negative electrode comprises forming the negative electrode material layer on the surface of the negative electrode current collector using a slurry. The slurry contains the negative electrode active material, the sulfide-based solid electrolyte, and a solvent (e.g., NMP). The step of producing a negative electrode may be performed by the method described in the first embodiment.

The thermocompression-bonding step comprises alternately disposing the positive electrode and the negative electrode, disposing a sulfide-based solid electrolyte layer between the positive electrode material layer and the negative electrode material layer, disposing a carbon layer between the positive electrode current collector and the negative electrode current collector, and integrating the resulting laminate by thermocompression bonding. The oxide-based solid electrolyte layer may be disposed between the positive electrode material layer and the sulfide-based solid electrolyte layer. The bipolar unit cell obtained by the thermocompression-bonding step is housed in a case. The positive and negative electrodes of the bipolar unit cell are electrically connected to the positive and negative electrode terminals to produce a bipolar battery.

The carbon layer is formed by, for example, the following method. A carbon paste is prepared by kneading a carbon material and a binder in the presence of a solvent. The resulting carbon paste is applied to one of the current collectors (e.g., a positive electrode current collector) and the other of the current collectors (e.g., a negative electrode current collector) is laminated on the carbon paste so that the carbon layer can be disposed between the positive electrode current collector and the negative electrode current collector. Accordingly, it is possible to easily connect the positive electrode current collector to the negative electrode current collector and decrease the resistance between the positive electrode current collector and the negative electrode current collector. In this regard, the carbon layer to be used in the first embodiment may be formed by the same method as that of the second embodiment.

In the second embodiment, it is not configured that a positive electrode material layer is formed on one surface of a current collector and a negative electrode material layer is formed on the other surface thereof. The current collector in which the positive electrode material layer is formed is different from the current collector in which the negative electrode material layer is formed. The negative electrode material layer may be produced in the presence of water. However, if the positive electrode material layer is produced in the presence of water, hydrogen sulfide may be generated. In order to avoid this, the current collector in which the positive electrode material layer is formed is apart from the current collector in which the negative electrode material layer is formed. According to the second embodiment, a carbon layer is interposed between the positive electrode current collector and the negative electrode current collector to electrically connect the positive electrode current collector and the negative electrode current collector. Thus, it is possible to easily connect the positive electrode current collector to the negative electrode current collector and decrease the resistance between the positive electrode current collector and the negative electrode current collector. Further, the carbon layer becomes a heating element by Joule heat during charge and discharge so that the input/output performance of the battery can be improved. As a result, it is possible to provide a bipolar battery excellent in discharge performance, low-temperature performance, cycle life performance, and high-temperature storage performance.

### EXAMPLES

Hereinafter, examples will be described in detail with reference to the drawings.

### Example 1

As positive electrode active material particles, LiNi_{0.5}Mn_{1.5}O₄ particles having an average particle size of 3 μm were prepared. The surfaces of the LiNi_{0.5}Mn_{1.5}O₄ particles were covered with an oxide-based solid electrolyte layer having a thickness of 0.05 μm by adhering Li_{1.5}Al_{0.5}Ti_{1.5}(PO₄)₃ particles having an average particle size of 0.01 μm (as the oxide-based solid electrolyte) to the surfaces of the LiNi_{0.5}Mn_{1.5}O₄ particles at a coating weight of 0.1% by mass. The thickness of the oxide-based solid electrolyte layer is measured by observation with a transmission electron microscope (TEM).

By mass, 3% of acetylene black and 5% by mass of graphite powder as conductive agents based on the total amount of the positive electrode and 5% by mass of PVdF as a binder based on the total amount of the positive electrode were added to the positive electrode active material particles. The resulting mixture was dispersed into an n-methyl-pyrrolidone (NMP) solvent to prepare a slurry. Then, 20% by mass of Li_{1.5}Al_{0.5}Ti_{1.5}(PO₄)₃ particles having an average particle size of 1 μm was added thereto, which was dispersed again to prepare a final slurry. This slurry was applied to both sides of a 15-μm-thick aluminum alloy foil (purity: 99% by mass), which was then treated through drying and pressing processes to produce a positive electrode in which the thickness of the positive electrode material layer on one surface was 43 μm and the electrode density was 2.2 g/cm³. The average potential of the positive electrode was 4.7 V (vs. Li/Li+).

As the negative electrode active material, spinel-type lithium titanate (Li₄Ti₅O₁₂) powder having an average particle size of primary particles of 0.3 μm, a BET specific surface area of 15 m²/g, a Li-absorption potential of 1.55 V (vs. Li/Li+) was prepared.

The negative electrode active material, acetylene black as the conductive agent, and PVdF as the binder were mixed at a mass ratio of 95:3:2. The resulting mixture was dispersed in an n-methyl-pyrrolidone (NMP) solvent. By mass, 20% of sulfide-based solid electrolyte particles of Li_{10/3}Ge_{1/3}P_{2/3}S₄ (average particle size: 1 μm) was added thereto, followed by re-dispersion with a ball mill. The resulting slurry was applied to both sides of a 15-μm-thick aluminum alloy foil (purity: 99.3% by mass), which was then treated through drying and heat-pressing processes to produce a negative electrode in which the thickness of the negative electrode material layer on one surface was 59 μm.

A composite obtained by mixing sulfide-based solid electrolyte particles of Li_{10/3}Ge_{1/3}P_{2/3}S₄ having an average particle size of 10 μm with alumina particles having an average particle size of 0.1 μm at a volume ratio of 1:1 was subjected to heat-press molding to produce a sulfide-based solid electrolyte layer having a thickness of 30 μm. The thickness of the sulfide-based solid electrolyte layer is measured by observation with a transmission electron microscope (TEM).

The sulfide-based solid electrolyte layer was disposed between the positive electrode material layer of the positive electrode and the negative electrode material layer of the negative electrode. These layers were integrated by heat-press molding to produce an electrode group. The electrode group was housed in a case formed of a laminate film and vacuum-sealed to produce a thin-type solid electrolyte secondary battery having a thickness of 1 mm, width of 40 mm, and a height of 60 mm.

### Examples 2 to 10 and Comparative Examples 1 to 3

Secondary batteries were produce in the same manner as in Example 1 except that the kind and layer thickness of the positive electrode active material, the negative electrode active material, and the oxide-based solid electrolyte as well as the kind and layer thickness of the sulfide-based solid electrolyte were changed as shown in Table 1. The average potential of the positive electrodes of Examples 9 and 10 was 3.8 V (vs. Li/Li⁺).

### Comparative Example 4

A nonaqueous electrolyte obtained by dissolving 1 M LiPF₆ in propylene carbonate (PC) was used in place of the solid electrolyte. The solid electrolyte was not contained in the material layers of the positive and negative electrodes. In place of the solid electrolyte layer, a separator of a polyethylene porous film (30 μm in thickness) was interposed between the material layers of the positive and negative electrodes. A thin-type secondary battery was produced in the same manner as in Example 1 except for the above-mentioned point.

### (Discharge Capacity at 25° C.)

The secondary batteries of Examples 1 to 8 and Comparative examples 1 to 4 were charged up to 3.3 V with a constant current of 100 mA (0.5 C) at 25° C. for 5 hours and discharged up to 2 V with a constant current of 100 mA. Then, their discharge capacities were measured. In Examples 9 and 10, each battery was charged up to 2.8 V with a constant current of 100 mA (0.5 C) at 25° C. for 5 hours and discharged up to 1.5 V with a constant current of 100 mA. Then, their discharge capacities were measured.

### (Capacity-Maintenance Ratio at 0° C.)

The secondary batteries of Examples 1 to 8 and Comparative examples 1 to 4 were charged up to 3.3 V with a constant current of 100 mA (0.5 C) at 0° C. for 5 hours and discharged up to 2 V with a constant current of 100 mA. Then, their discharge capacities were measured. In Examples 9 and 10, each battery was charged up to 2.8 V with a constant current of 100 mA (0.5 C) at 0° C. for 5 hours and discharged to 1.5 V with a constant current of 100 mA. Then, their discharge capacities were measured. The resulting discharge capacities are shown in Table 1 below so that a value represented based on the discharge capacity at 25° C.=100% is the capacity-maintenance ratio at 0° C.

### (Capacity-Maintenance Ratio at 3 C Rate)

The secondary batteries of Examples 1 to 8 and Comparative examples 1 to 4 were charged up to 3.3 V with a constant current of 100 mA (0.5 C) at 25° C. for 5 hours and discharged to 2 V with a constant current of 600 mA (3 C). Then, their discharge capacities were measured. In Examples 9 and 10, each battery was charged up to 2.8 V with a constant current of 100 mA (0.5 C) at 25° C. for 5 hours and discharged to 1.5 V with a constant current of 600 mA (3 C). Then, their discharge capacities were measured. The resulting discharge capacities are shown in Table 1 below so that a value represented based on the discharge capacity at 25° C.=100% is the capacity-maintenance ratio at the 3 C rate.

### (Cycle Life at 60° C.)

The charge and discharge cycle was repeated in an environment of 60° C. The time when the capacity reached 80% was defined as the cycle life. The batteries of Examples 1 to 8 and Comparative examples 1 to 4 exhibited an open circuit potential of 3 V when discharged to 50%. Examples 9 and 10 exhibited an open circuit potential of 2 to 3 V when discharged to 50%.

These measurement results are shown in Table 2 below.

TABLE 1

| | | The solid electrolyte layer bonded | | Negative | The solid electrolyte layer bonded to | |
|---|---|---|---|---|---|---|
| | | to the positive electrode | | electrode | the negative electrode | |
| | Positive electrode | | Thickness | active | | Thickness |
| | active material | Kind | (μm) | material | Kind | (μm) |
| Example 1 | LiNi_{0.5}Mn_{1.5}O₄ | Li_{1.5}Al_{0.5}Ti_{1.5}(PO₄)₃ | 0.05 | Li₄Ti₅O₁₂ | Li_{10/3}Ge_{1/3}P_{2/3}S₄•Al₂O₃ | 30 |
| Example 2 | LiNi_{0.5}Mn_{1.5}O₄ | Li_{1.5}Al_{0.5}Ti_{1.5}(PO₄)₃ | 0.01 | Li₄Ti₅O₁₂ | Li_{10/3}Ge_{1/3}P_{2/3}S₄ | 50 |
| Example 3 | LiNi_{0.5}Mn_{1.5}O₄ | Li₄Ti₅O₁₂ | 0.001 | Li₄Ti₅O₁₂ | Li_{10/3}Ge_{1/3}P_{2/3}S₄•Al₂O₃ | 30 |
| Example 4 | LiNi_{0.5}Mn_{1.5}O₄ | Li_{1.5}Al_{0.5}Ti_{1.5}(PO₄)₃ | 0.5 | Li₄Ti₅O₁₂ | Li_{10/3}Ge_{1/3}P_{2/3}S₄•Al₂O₃ | 30 |
| Example 5 | LiNi_{0.5}Mn_{1.5}O₄ | Li_{0.35}La_{0.55}TiO₃ | 0.05 | Li₄Ti₅O₁₂ | Li_{10/3}Ge_{1/3}P_{2/3}S₄•Al₂O₃ | 30 |
| Example 6 | LiNi_{0.5}Mn_{1.5}O₄ | Li₁₄ZnGe₄O₁₆ | 0.05 | Li₄Ti₅O₁₂ | Li_{10/3}Ge_{1/3}P_{2/3}S₄•Al₂O₃ | 30 |
| Example 7 | LiNi_{0.5}Mn_{1.5}O₄ | Li_{1.5}Al_{0.5}Ti_{1.5}(PO₄)₃ | 0.05 | TiS₂ | Li_{10/3}Ge_{1/3}P_{2/3}S₄•Al₂O₃ | 30 |
| Example 8 | LiNi_{0.5}Mn_{1.5}O₄ | Li_{1.5}Al_{0.5}Ti_{1.5}(PO₄)₃ | 0.05 | FeS | Li_{10/3}Ge_{1/3}P_{2/3}S₄•Al₂O₃ | 30 |
| Example 9 | LiNi_{0.8}Co_{0.1}Mn_{0.1}O₂ | Li_{1.5}Al_{0.5}Ti_{1.5}(PO₄)₃ | 0.05 | TiO₂(B) | Li_{10/3}Ge_{1/3}P_{2/3}S₄•Al₂O₃ | 30 |
| Example 10 | LiNi_{0.8}Co_{0.1}Mn_{0.1}O₂ | Li_{1.5}Al_{0.5}Ti_{1.5}(PO₄)₃ | 0.05 | Li₄Ti₅O₁₂ | Li_{10/3}Ge_{1/3}P_{2/3}S₄•Al₂O₃ | 30 |
| Comparative | LiNi_{0.5}Mn_{1.5}O₄ | Li_{1.5}Al_{0.5}Ti_{1.5}(PO₄)₃ | 1 | Li₄Ti₅O₁₂ | Li_{10/3}Ge_{1/3}P_{2/3}S₄ | 30 |
| example 1 | | | | | | |
| Comparative | LiNi_{0.5}Mn_{1.5}O₄ | Li_{10/3}Ge_{1/3}P_{2/3}S₄ | 0.05 | Li₄Ti₅O₁₂ | Li_{10/3}Ge_{1/3}P_{2/3}S₄ | 30 |
| example 2 | | | | | | |
| Comparative | LiNi_{0.5}Mn_{1.5}O₄ | Li_{10/3}Ge_{1/3}P_{2/3}S₄ | 30 | Li₄Ti₅O₁₂ | Li_{1.5}Al_{0.5}Ti_{1.5}(PO₄)₃ | 1 |
| example 3 | | | | | | |
| Comparative | LiNi_{0.5}Mn_{1.5}O₄ | — | — | Li₄Ti₅O₁₂ | — | — |
| example 4 | | | | | | |

TABLE 2

| | Discharge | Capacity- | Capacity- | |
|---|---|---|---|---|
| | capacity | maintenance | maintenance | Cycle |
| | at 25° C. | ratio at | ratio at | life at |
| | (m Ah) | 3 C. (%) | 0° C. (%) | 60° C. |
| Example 1 | 200 | 75 | 50 | 1200 |
| Example 2 | 200 | 75 | 60 | 1000 |
| Example 3 | 210 | 80 | 60 | 800 |
| Example 4 | 180 | 60 | 40 | 1500 |
| Example 5 | 200 | 70 | 50 | 1000 |
| Example 6 | 200 | 70 | 50 | 1000 |
| Example 7 | 220 | 80 | 80 | 1500 |
| Example 8 | 280 | 60 | 60 | 800 |
| Example 9 | 240 | 70 | 50 | 1000 |
| Example 10 | 240 | 60 | 30 | 2500 |
| Comparative | 100 | 10 | 10 | 1000 |
| example 1 | | | | |
| Comparative | 120 | 20 | 20 | 100 |
| example 2 | | | | |
| Comparative | 50 | 10 | 10 | 200 |
| example 3 | | | | |
| Comparative | 200 | 60 | 60 | 50 |
| example 4 | | | | |

As is clear from Tables 1 and 2, the solid electrolyte secondary batteries of Examples 1 to 10 have a higher discharge capacity maintenance rate at a high rate of 3 C and a higher discharge capacity maintenance rate in a low temperature environment of 0° C. as compared with Comparative examples 1 to 4. Further, Examples 1 to 10 are excellent in cycle life performance in a hot environment of 60° C. Therefore, the solid electrolyte secondary batteries of Examples 1 to 10 are excellent in discharge performance, low-temperature performance, cycle life performance, and high-temperature storage performance.

### Example 11

Further, the four electrode groups of the solid electrolyte secondary batteries of Example 1 were connected in series with a carbon layer to produce a bipolar battery of Example 11 having the structure shown in FIG. 2. First, as for the carbon layer, a carbon paste was prepared by kneading a carbon material (e.g., a graphite material or a carbonaceous material) and a binder (e.g., a rubber-based material or a fluorine-based resin) in the presence of a solvent (e.g., NMP). The resulting carbon paste was applied to the positive electrode current collector of the first electrode group. Thereafter, the negative electrode current collector of the second electrode group was laminated on the carbon paste. The carbon paste was applied to the positive electrode current collector of the second electrode group. Thereafter, the negative electrode current collector of the third electrode group was laminated on the carbon paste. The carbon paste was applied to the positive electrode current collector of the third electrode group. Thereafter, the negative electrode current collector of the fourth electrode group was laminated on the carbon paste. The resulting laminate was subjected to heat-pressing at 80° C. or more to produce a bipolar unit cell. The resulting bipolar unit cell was used to produce a bipolar battery of Example 11 having the structure shown in FIG. 2.

### Comparative Example 5

Four of the solid electrolyte secondary batteries of Comparative example 3 were prepared. The four batteries were connected in series by welding the terminals to produce a battery module of Comparative example 5.

The bipolar battery of Example 11 and the battery module of Comparative example 5 were subjected to float charging with a voltage of 14 V at 80° C. for three months. Thereafter, they were discharged at 0.5 C. The average voltage of Example 11 was 12 V and the remaining capacity was 90%. On the other hand, the average voltage of Comparative example 5 was 9 V and the remaining capacity was 20%. The bipolar battery of Example 11 exhibited excellent discharge performance and had excellent compatibility with the lead storage battery (12 V) even after the float charging in a hot environment.

### Example 12 and Comparative Example 6

Heaters for generating heat by power supply or discharge of the battery itself were placed around each of the bipolar battery of Example 11 and the battery module of Comparative example 5 to produce battery packs of Example 12 and Comparative example 6. These battery packs were left at −30° C. for 3 hours and then the discharge capacities (discharge at 0.2 C) were measured. As a result, in Example 12, the resulting discharge capacity was 140 mAh. On the other hand, the discharge capacity of Comparative example 6 was 0. According to the battery pack of Example 12, an excellent low-temperature discharge performance is given. Accordingly, the battery pack can be used as a vehicle starter power source or a large driving power source instead of a lead storage battery.

According to the electrochemical cell of at least one of the embodiments and the examples, an electrochemical cell excellent in discharge performance, low-temperature performance, cycle life performance, and high-temperature storage performance can be provided by covering the surfaces of positive electrode active material particles which absorb and release lithium ions at a potential of 3 V or more (vs. Li/Li⁺) with the oxide-based solid electrolyte layer having a thickness of 0.5 μm or less and bonding the sulfide-based solid electrolyte layer to the negative electrode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrochemical cell comprising:
a positive electrode comprising positive electrode active material particles which absorb and release lithium ions at a potential of 3 V (vs. Li/Li⁺) or more;
a negative electrode comprising a negative electrode active material;
a sulfide-based solid electrolyte layer which is bonded to the negative electrode; and
an oxide-based solid electrolyte layer having a thickness of 0.5 μm or less which is provided on surfaces of the positive electrode active material particles.

2. An electrochemical cell according to claim 1, comprising a carbon layer.

3. An electrochemical cell according to claim 1, wherein the positive electrode comprises a positive electrode current collector, and a positive electrode material layer comprising the positive electrode active material particles and provided on the positive electrode current collector,
and the negative electrode comprises a negative electrode current collector, and a negative electrode material layer comprising the negative electrode active material and provided on the negative electrode current collector, and the electrochemical cell comprises a carbon layer provided on the positive or negative electrode material layer, or the positive or negative electrode current collector.

4. An electrochemical cell according to claim 1, wherein the sulfide-based solid electrolyte layer contains metallic oxide particles.

5. An electrochemical cell according to claim 1, wherein the negative electrode active material contains at least one selected from the group consisting of lithium titanium oxide, titanium oxide, niobium oxide, silicon oxide, silicon, silicon alloy, and metal sulfide.

6. A battery pack comprising the electrochemical cell according to claim 1.

7. The battery pack according to claim 6, comprising a heater that heats the electrochemical cell.

8. A car comprising the battery pack according to claim 6.

9. A method of producing an electrochemical cell comprising:
forming a positive electrode material layer on a surface of a positive electrode current collector using a nonaqueous slurry to produce a positive electrode, and the nonaqueous slurry containing an oxide-based solid electrolyte, positive electrode active material particles absorbing and releasing lithium ions at a potential of 3 V (vs. Li/Li⁺) or more and an oxide-based solid electrolyte layer provided on surfaces of the positive electrode active material particles;
forming a negative electrode material layer on a surface of a negative electrode current collector using a slurry to produce a negative electrode, and the slurry containing a negative electrode active material and a sulfide-based solid electrolyte; and
disposing the positive electrode and the negative electrode with interposing a sulfide-based solid electrolyte layer between the positive electrode material layer and the negative electrode material layer, and with providing a carbon layer on the positive or negative electrode material layer, or the positive or negative electrode current collector, and integrating a resulting laminate by thermocompression bonding.
